(19) United States
(12) Patent Application Publication
(10) Pub. No.: US 2021/0022322 A1
(43) Pub. Date: Jan. 28, 2021

(54) METHOD AND SYSTEM FOR EXTRACTION OF STATISTICAL SAMPLE OF MOVING OBJECTS

(71) Applicant: GiliOcean Technology Ltd., Bnei Dror (IL)

(72) Inventors: Ebraheem SALEH, Abu Gosh (IL); Menachem TZIEGFINGER, Har-Adar (IL); Abshalom BAR SHALOM, Kibbutz Nahsholim, Hof Charmel (IL); Amitay PELEG, Haifa (IL); Ychiel SWIMIR, Bnai Dror (IL); Josef MELCHER, Tzur Itzchak (IL)

(21) Appl. No.: 16/980,486

(22) PCT Filed: Mar. 14, 2019
(86) PCT No.: PCT/IL2019/050290

§ 371 Date: Sep. 14, 2020

Related U.S. Application Data
(60) Provisional application No. 62/645,210, filed on Mar. 20, 2018.

(51) Int. Cl. A01K 61/95; G02B 27/20; G06K 9/00; G06K 9/62; G06N 20/00

(52) U.S. Cl. CPC A01K 61/95; G02B 27/20; G06N 20/00; G06K 9/6215; G06K 9/00362

(57) ABSTRACT

A system for extracting a statistical sampling of population of moving objects is provided herein. The system includes: (i) a light source pointer; (ii) an imaging device; and (iii) a processor. The light source pointer is configured to project a light source to a predefined direction for point marking moving objects. The imaging device is configured to: (i) face said predefined direction; (ii) capture images to record moving objects that are point marked by said light source; and (iii) send said images to said processor; The processor is configured to: (i) recognize images that include objects point marked by said light source pointer in a predefined range of angles appropriate for image processing; (ii) identify as relevant objects a predetermined size of statistical sample of objects from the recognized images based on machine learning process; and (iii) display a list of images of the identified relevant objects.

### TECHNICAL FIELD

The present disclosure relates to extraction of statistical sample of population of moving objects, in general. More specifically, the present disclosure relates to extraction of representative statistical sample of a population of moving objects by an imaging device and optical means.

### BACKGROUND

To control or manage a population of objects, measurement of the amount of the objects and their weight may be needed. Other measurements such as percentage of objects suffering from health issues out of the total amount of objects is also desired. When the population is of moving animals, the measurements may be a fundamental practice to provide an accurate daily amount of food or medication, track the growth rate of the animals and determine optimum time for harvest. However, measurements of animals while moving can be a complicated task. For that purpose, there are several methods known in the art.

An example of a population of moving objects may be fish. A common method to measure the amount and weight of fish is by randomly and manually plucking a couple of dozens of fish as a sample and then calculating the total weight of the fish in the sample. The average weight of the fish is calculated by dividing the total weight of the fish in the sample by the number of fish. However, because this sampling method is not convenient to conduct, it is performed only once in a couple of weeks under the assumption that growth rate between current sample and previous one is the same as the growth rate between previous sample and the one before. A deficiency of this method is that this assumption is wrong and it does not conform to modern agriculture, which aspires precision agriculture in which a constant and on-line monitoring is performed and facilitated by various sensors.

Another method known in the art to measure fish is by streaming the fish via a pipe system. For example, in the method disclosed in US Patent US 20080137104 A1 “a method for recording and estimation of the weight of fish. A number of cameras, especially CCD-cameras, record pictures of fish moving by the cameras in a transfer conduit. The fish are illuminated from different sides in the transfer conduit and pictures of different parts of the fish are recorded by a sequence control, in such a way that a compound image recording is made, which is used as a base for an estimation of the weight of fish. A device to make measurements on fish 11, moving in a transfer conduit 12, that has at least two light sources 14 at the wall of the transfer conduit, for illumination of fish, and two or several cameras 10, especially CCD-cameras, arranged in a cross plane evenly around the circumferences, to record reflections from the fish or shadow pictures of the fish.” However, a deficiency of this method is the requirement to either pass all the population of the fish via the pipe system or take a sample of the population hence risking in the possibility of receiving participation bias or non-response bias.

A method to sample a population of animals and extrapolating the result to the whole population is disclosed in Pentair website. “A frame is placed in each cage and the wireless radio link from the cage automatically transfers the data to a center base. All measurements are available in a web-based reporting application, which can automatically send daily detailed reports to selected recipients.” According to this method the fish voluntarily pass through a data collecting frame. However, a deficiency of this method is that all fish presented on a screen are taken into account as part of the sample size, causing the sample size to be too large, thus making the sample not random enough, hence extrapolate less accurate measurements.

Yet another method to measure fish size, fish quantity and total fish biomass is disclosed in US 20060018197 A1. In the disclosed method “The fish are located in a seacage in a body of water. A mobile platform is placed on the surface water above the seacage and is moved in a transect pattern above the seacage. A transducer with associated transceiver attached to the mobile platform generates an echo pattern that is converted by a processor into estimates relating to fish size, fish quantity, and total fish biomass data of the fish located in the seacage.” The deficiency of this method is that it measures, by acoustic resonance return, the mass of the whole fish population, and does not preform single fish measurements, thus making this method not accurate enough. For example, the method provides no specific or individual data in order to determine population distribution.

All known prior art discloses systems and methods which require more than one imaging device for image processing. There is a need for a method and system for statistical measurement of population of moving objects where the sample retrieved from the population is representative to extrapolate accurate results by using a simpler system.

### SUMMARY

There is thus provided, in accordance with some embodiments of the present disclosure, a simple system for accurately extracting a statistical sampling of population of moving objects According to some embodiments, the system comprises a single imaging device and a single light source pointer. In some embodiments, the system is comprising: a light source pointer; an imaging device; and a processor. The light source pointer is configured to project a light source to a predefined direction for point marking moving objects. The imaging device is configured to: (i) face the predefined direction; (ii) capture images to record moving objects that are marked by a light beam point by said light source; and (iii) send the images to the processor. The processor is configured to: (i) recognize images that include objects that are marked by a light beam point by the light source in a predefined range of angles; (ii) identify as relevant objects a predetermined size of statistical sample of objects from the recognized images based on machine learning process; and (iii) display a list of images of the identified relevant objects. The list of relevant objects provides a statistical sample of population of moving objects for statistical measurements.

Furthermore, in accordance with some embodiments of the present disclosure, the processor is further configured to: (i) calculate distance between the imaging device and the relevant; and (ii) calculate body area of the objects based on the calculated distance and shape of the object. The processor may be further configured to calculate distance using a light beam point mark on the object.

There is further provided, in accordance with some embodiments of the present disclosure, the processor is further configured to display a distribution of the population when the identified relevant objects are combined of one or more types of objects. The one or more types of objects are selected from a group consisting of: species, shape, color, spots and flecks of the object.

Moreover, the machine learning process of the system is performed according to a provided parameter.

In some embodiments, the provided parameter is selected from a group consisting of: shape, color, spots, flecks of the object, position in space and locomotion of the object.

Furthermore, the system may be located inside a closed area. Alternatively, the system may be located outside the closed area and directed to mark with a light source point the moving objects and capture an image to record potential relevant objects for the statistical sample. Alternatively, the system may be located in a virtually marked area, which may designate an area that does not contain physical boundaries but instead the boundaries of the area are virtual, and their definition may change per user preferences.

There is further provided a method for extracting a statistical sample of population of moving objects. The method comprising: (i) receiving a size of a statistical sample; (ii) determining criteria for machine learning process to identify objects as relevant objects; (iii) projecting a light beam to a predefined direction for point marking moving objects; (iv) facing an imaging device to the predefined direction to capture an image by the imaging device; (v) capturing an image to record light beam point marked moving objects; (vi) sending the image to a processor; (vii) recognizing images that include objects that are marked by the light source pointer in a predefined range of angles appropriate for image processing; (viii) identifying an object marked by light beam point in the captured image as relevant objects according to the determined criteria by the processor; and (ix) displaying a list of images of the identified relevant objects having the received size of a statistical sample. The list of relevant objects provides a statistical sample of population of moving objects for statistical measurements.

In accordance with some embodiments of the present disclosure, the method further comprising: (i) calculating distance between the imaging device and the relevant objects; and (ii) calculating body area of the objects based on the calculated distance and shape of the object. The step of calculating distance and the step of calculating body area may be performed by the processor. The calculating of distance may be carried out by using a light beam point mark on the object.

In accordance with some embodiments of the present disclosure, the method may further comprise a step of identifying relevant objects which are combined of one or more types of objects. The one or more types of objects may be selected from a group consisting of: species, shape, color, spots and flecks of the object.

Furthermore, the method may further comprise a step of displaying a distribution of the population by the processor.

In some embodiments, the machine learning process of the method is performed according to a provided parameter.

In some embodiments, the provided parameter is selected from a group consisting of: shape, color, spots, flecks of the object, position in space and locomotion of the object.

### BRIEF DESCRIPTION OF THE DRAWINGS

Some non-limiting exemplary embodiments or features of the disclosed subject matter are illustrated in the following drawings.

In the drawings:

FIG. 1A is a diagram schematically illustrating one form of a system for extracting a statistical sampling of population of moving objects, where a light source point marks a relevant object, according to one embodiment of the disclosure;

FIG. 1B is a diagram schematically illustrating one form of a system for extracting a statistical sampling of population of moving objects, where a light source does not point mark an object, according to another embodiment of the disclosure;

FIG. 1C is a diagram schematically illustrating one form of a system for extracting a statistical sampling of population of moving objects, where a light source point marks a portion of an object, according to yet another embodiment of the disclosure; and

FIG. 2 is a schematic flow chart illustrating a method for extracting a statistical sampling of population of moving objects, according to some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “mark” or “marked” or “point marked” in this description refers to mark which is not permanent on the object but as a point shape or a cross shape or any other shape of a light beam that is showing on an object.

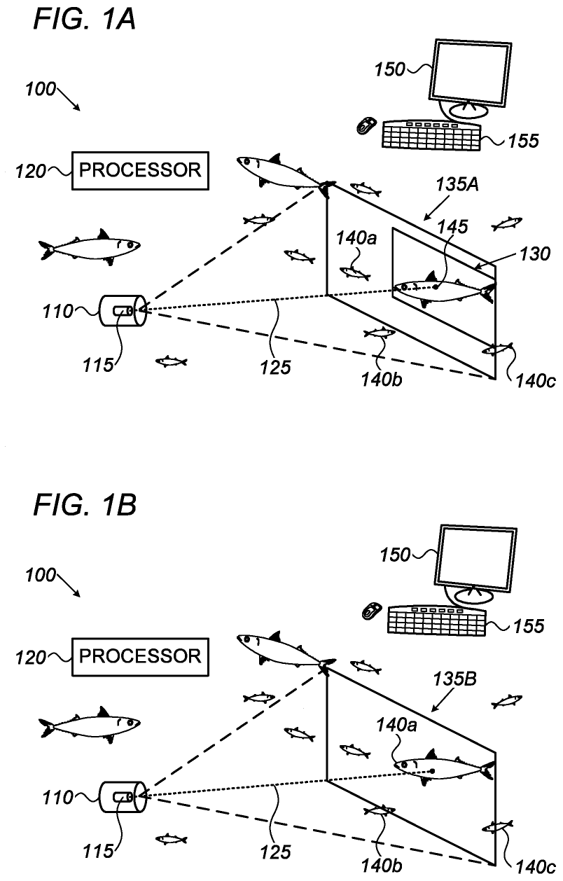

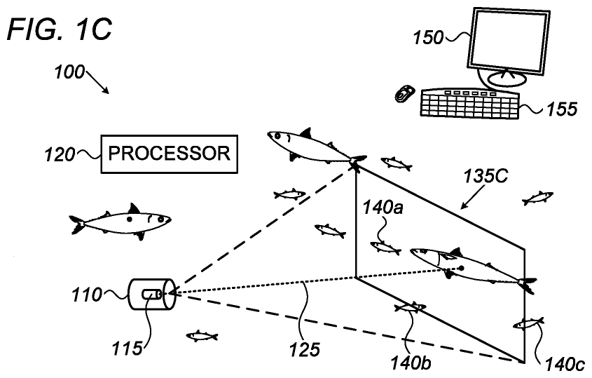

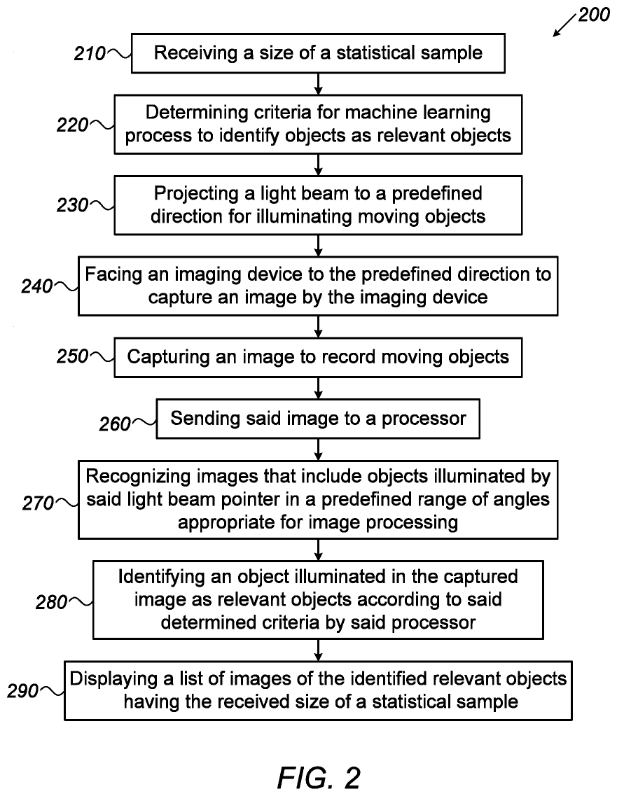

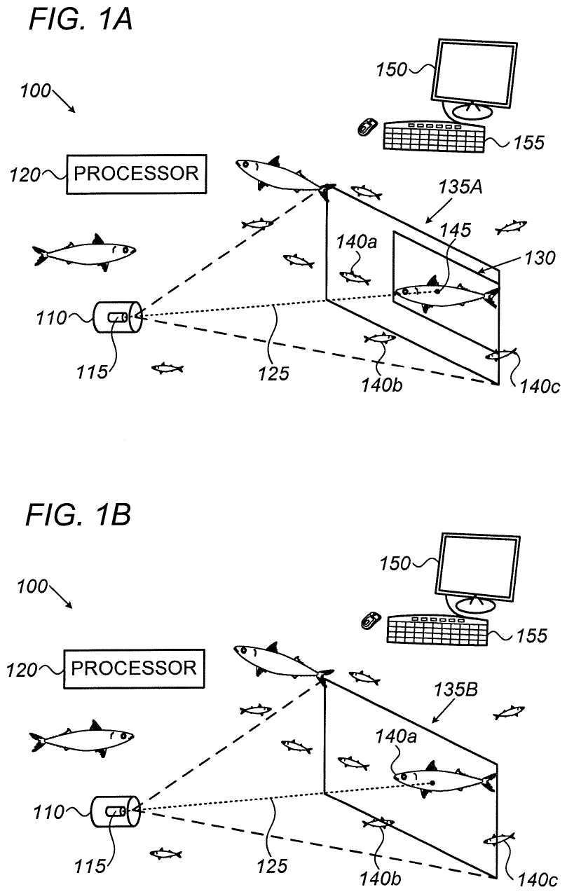

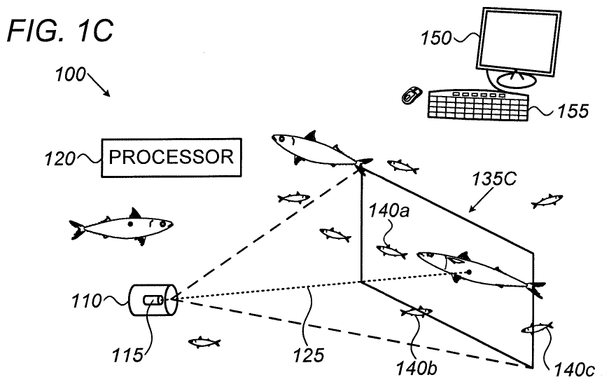

A system may be configured to extract a statistical sampling of population of moving objects for statistical measurements. A statistical measurement may be, in a non-limiting example, the weight of the objects. In the example of FIG. 1, such a system is shown. The system 100 includes a processor 120. For example, processor 120 may include one or more processing units, e.g., of one or more computers. Processor 120 may be configured to operate in accordance with programmed instructions stored in memory. Processor 120 may be capable of executing an application for identifying a predetermined amount of light beam marked moving objects as relevant objects in the captured images according to predefined criteria based on machine learning process and providing a list of images of the relevant objects. The machine learning process may be performed according to a provided parameter. In some embodiments, the provided parameter may be selected from a group consisting of: shape, color, spots, flecks of the object, position in space and locomotion of the object.

Processor 120 may communicate with output device 150. For example, output device 150 may include a computer monitor or screen. Processor 120 may communicate with a screen of output device 150 to display the list of images of the relevant objects. In another example, output device 150 may include a printer, display panel, speaker, or another device capable of producing visible, audible, or tactile output. As such, output device 150 may deliver a printout of the list of images of the relevant objects.

According to some embodiments of the present disclosure, processor 120 may communicate with input device 155. For example, input device 155 may include one or more of a keyboard, keypad, or pointing device for enabling a user to input data or instructions for operation of processor 120.

A user (not shown) may enter via input device 155 the size of the statistical sample, i.e., number of objects that is required for the statistical sample, for example, the number of relevant objects in the list of images.

The present disclosure will be described below in more details with reference to the attached drawings, where

FIG. 1A is a diagram illustrating one form of a system for extracting a statistical sampling of population of moving objects, where a light source pointer marks a relevant object.

According to one embodiment of the present disclosure, a light source pointer 115, may project a static beam 125 in a parallel direction to the centerline of the imaging device field of view. An imaging device such as a camera 110 faces the same direction as the light source pointer 115 and captures an image 135A to record moving objects point marked by the light source pointer 115. According to some embodiments of the disclosure, the light source pointer may be a laser beam pointer, a LED pointer or any type of other source of light.

The captured image 135 may include moving objects such as objects 140a-c and light beam point marked object 130. The camera 110 may send the captured image 135A to the processor 120 for image processing.

In operation, the processor 120 may recognize the captured image 135A as having an object that was point marked by the light source pointer 115 in a predefined range of angles of the object relative to the light beam as appropriate for image processing. For example, 90 degrees between an object and the light beam 125 may be considered an appropriate angle for image processing, in case the body area of the object is to be calculated by image processing. Then, if the captured image 135A was recognized as appropriate for image processing, processor 120 may execute a method for identifying an object as a relevant object based on a machine learning process, thereafter. In case an object was not point marked in the predefined range of angles, the processor 120 will not perform image processing as will be elaborated in detail with respect to FIG. 1C.

It should be noted that different ranges of angles may be appropriate for different types of image processing. That is, in the example of image processing intended for calculating the weight of objects, the predefined angle at which the object should be located with respect to imaging device 110, in order to measure body area of the object, should be of substantially 90 degrees, such that substantially the entire body area of the object is captured by the imaging device 110. However, in other cases, for example, when monitoring of a disease of the objects, e.g., a skin disease, is required, other predefined angles or predefined range of angles may be suitable for detection of such diseases. In case a disease is to be monitored, the object need not necessarily be positioned substantially perpendicularly to the light beam 125, but may rather be positioned in various other angles, as long as appearance of some of the object's disorder may be noticed in an image captured by imaging device 110.

The objects point marked by the light source pointer 115 and captured by the imaging device 110 are moving in different directions and not positioned in the same place at all times. Therefore, the combination of the random movement of the objects and the static light beam and imaging device ensures that varied objects are captured by the imaging device 110, thus, making the sample of relevant objects random and proper for statistical measurements. According to some embodiments, a certain number of images is captured per second. For example, 30 images per second. Thus, a machine learning process may identify the locomotion of an object, e.g., by comparing a certain number of consecutive images. According to some embodiments, to identify possible marine pollution causing fish illness, the locomotion of fish may be identified by the system 100, for example, based on a known fact that a sick fish tends to lay on its side.

According to some embodiments, the processor 120 may determine a shape of the relevant object and the distance between the camera 110 and the identified moving objects, e.g., object 130, by implementing an image processing method. According to some embodiments, the distance between camera 110 and the identified moving objects may be calculated by using a light beam point mark 145 on the object. In some embodiments, measurements of the distance between a relevant object and the imaging device 110 may be based on distance between the object and light source pointer 115, which may be calculated based on the light beam point mark 145 on the object. However, in other embodiments, the distance between imaging device 110 and a relevant object may be calculated using methods which exclude the use of the light beam point mark 145 on the object. The processor 120 may also determine colors, spots, flecks, way of movement or lack of movement and position in space of the objects in order to detect skin disease of the objects. For example, a position in space may be a flapping fish, which might indicate that the fish is sick. In another example, some pattern or the mere presence of spots on the fish skin may indicate a skin disorder.

According to some embodiments, the system 100 may be located inside a closed area, for example, in the same closed area where the moving objects are located, or alternatively, the system 100 may be located outside a closed area and be directed to point mark the moving objects and capture an image to record potential relevant objects for the statistical sample. According to yet some other embodiments, the system 100 may be positioned in a virtually marked area.

Accordingly, based on the determined distance and shape of each object, the weight of the objects in the list of images of relevant objects, may be calculated, as further elaborated in Frank S. Berent D., Weight estimation of flatfish by means of structured light and image analysis, Fisheries Research, Volume 11, Issue 2, April 1991, Pages 99-108. Thereby, the present disclosure may provide for example, a statistical sample of the weight of the objects of the measured population.

Monitoring the effectiveness of the nutrition provided to animals is a necessary operation in controlling or managing a population of various types of animals. According to some embodiments, the relevant objects that are to be sampled as part of the statistical measurements may be combined of one or more types of objects. The one or more types of objects are selected from a group consisting of: species, shape, color, spots and flecks of the object. For example, in case the animals are fish residing in a fish pool, the relevant objects may be combined of sea-bass and of trout (and/or any other types of fish that live in pools). The processor 120 may display on an output device 150 a distribution of the population of the objects. In such case, the system 100 may provide a list of images of relevant objects for each predefined types for statistical measurements. The statistical measurements may reveal that a growth rate of a weak population is lower than the growth rate of a stronger population, e.g., animals with higher weight, which may mean that the stronger population is growing on the expense of the weaker population. Correspondingly, a farmer who controls and manages the population of various types might seek for a solution such as separating the different types or increasing the accessibility of the food to the weaker population. In another example, the animals are fish of the same species where male fish are red colored and female fish are grey colored. In such case, the system 100 may provide a list of images of relevant objects for male and female according to their colors for statistical measurements. The statistical measurements track fish reproduction. In yet another example, the system 100 may operate to provide a list of images of relevant objects where the relevant objects have skin disease based on machine learning process.

FIG. 1B is a diagram illustrating one form of a system for extracting a statistical sampling of population of moving objects, where a light beam 125 projected by light source pointer 115 does not point mark an object. According to some embodiments, in case the light beam 125 does not point mark any object and the processor 120 receives such an image 135B the processor may discard the image 135B.

FIG. 1C is a diagram illustrating one form of a system for extracting a statistical sampling of population of moving objects, where a light beam point marks a portion of an object.

According to some embodiments, when the processor 120 receives an image 135C where the light beam 125 point marks an object 130 that is in a relative angle to the light beam that is not appropriate for image processing the processor may discard the image 135C. For example, when the system 100 is configured to identify an object 130, and object 130 is positioned at an angle substantially other than 90 degrees to the light beam 125, as illustrated in the image 135C, since the angle at which object 130 is positioned with respect to light beam 125 is not appropriate for image processing of body area, image 135C may be discarded and not included in the process of statistical sampling. That is, in the example where body area of an object, e.g., object 130, should be measured via image processing in order to determine weight of the object 130, an angle of substantially 90 degrees should be present between the object 130 and the light beam 125, thus enabling imaging device 110 to capture substantially the entirety of the object's body area. However, it should be noted that for image processing of other object characteristics, other angles or ranges of angles may be relevant.

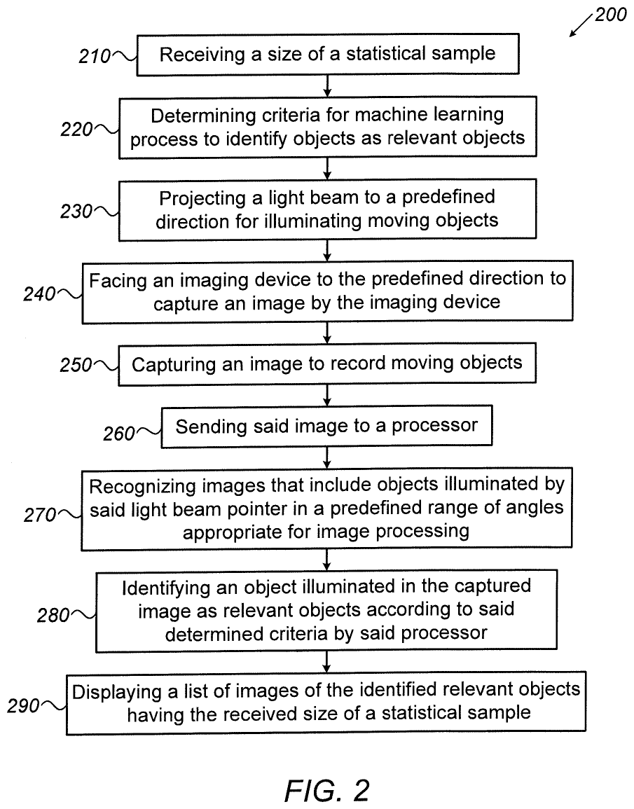

FIG. 2 is a flowchart depicting a method for extracting a statistical sample of population of moving objects. In the Example of FIG. 2, a method 200 may be executed by a processor of a system for extracting a statistical sample of population of moving objects. The method 200 may be executed upon a request or command that is issued by a user, or automatically issued by another application. The method comprises operation 210, which includes receiving a size of a statistical sample from the input device 155. A statistical sample size according to the present disclosure, may comprise a number of images captured by the system 100 that match a predefined object, e.g., object 130, which was point marked by the light beam 125. A statistical sample size may be of minimum thirty images. The size of one or more statistical samples may be predefined according to the amount of types of relevant objects. In some embodiments, operation 220 may comprise determining criteria for machine learning process to identify objects as relevant objects. In a non-limiting example, criteria for machine learning process may be color or shape of an object, locomotion and position in space of the object. The relevant objects may be of one or more types, e.g., of one or more animal types. In some embodiments, the one or more types of objects may be of different species, shape, color, spots or flecks of the object. In operation 230 a light beam is projected to a predefined direction for point mark moving objects. In the following operation 240, an imaging device is facing at the predefined direction to capture an image by the imaging device. In some embodiments, method 200 may comprise operation 250, in which an image is captured to record light beam point marked moving objects. In some embodiments, operation 260 may comprise sending the captured image to a processor, e.g. processor 120. Operation 270 may comprise recognizing images that include objects that are point marked by the light source pointer in a predefined range of angles appropriate for image processing; Operation 280 may comprise identifying an object point marked in the captured image as a relevant object according to the determined criteria by the processor. according to some embodiments, method 200 may comprise operation 290, which may include displaying a list of images of the identified relevant objects having the received size of a statistical sample. The list of relevant objects provides a statistical sample of population of moving objects for statistical measurements.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

1. A system for extracting a statistical sampling of population of moving objects, the system comprising:
a light source pointer;
an imaging device; and
a processor,
wherein said light source pointer is configured to project a light source to a predefined direction for point marking moving objects;
said imaging device is configured to: (i) face said predefined direction; (ii) capture images to record moving objects that are point marked by said light source; and (iii) send said images to said processor;
wherein said processor is configured to:
recognize images that include objects point marked by said light source pointer in a predefined range of angles appropriate for image processing;
identify as relevant objects a predetermined size of statistical sample of objects from the recognized images based on machine learning process; and
display a list of images of the identified relevant objects,
wherein the list of relevant objects provides a statistical sample of population of moving objects for statistical measurements.

2. The system of claim 1, wherein said processor is further configured to: (i) calculate distance between said imaging device and said relevant objects; and (ii) calculate body area of said objects based on said measured distance and shape of said object.

3. The system of claim 2, wherein said processor is further configured to calculate distance using a light source point mark on the object.

4. The system of claim 1, wherein said identified relevant objects are combined of one or more types of objects.

5. The system of claim 1, wherein the one or more types of objects are selected from a group consisting of: species, shape, color, spots and flecks of the object.

6. The system of claim 4, wherein said processor is further configured to display a distribution of the population.

7. The system of claim 1, wherein the machine learning process is performed according to a provided parameter.

8. The system of claim 7, wherein the provided parameter is selected from a group consisting of: shape, color, spots, flecks of the object, position in space and locomotion of the object.

9. The system of claim 1, wherein the system is located inside a closed area or in a virtually marked area.

10. A method for extracting a statistical sample of population of moving objects, the method comprising:
receiving a size of a statistical sample;
determining criteria for machine learning process to identify objects as relevant objects;
projecting a light source to a predefined direction for point marking moving objects;
facing an imaging device to the predefined direction to capture an image by the imaging device;
capturing an image to record point marked moving objects;
sending said image to a processor;
recognizing images that include objects point marked by said light source pointer in a predefined range of angles appropriate for image processing;
identifying an object point marked in the captured image as relevant objects according to said determined criteria by said processor; and
displaying a list of images of the identified relevant objects having the received size of a statistical sample,
wherein the list of relevant objects provides a statistical sample of population of moving objects for statistical measurements.

11. The method of claim 10, the method further comprising: (i) calculating distance between said imaging device and said relevant objects; and (ii) calculating body area of said objects based on said calculated distance and shape of said object, wherein the step of calculating distance and the step of calculating body area are performed by said processor.

12. The method of claim 11, wherein the step of calculating distance is carried out by using a light source point mark on the object.

13. The method of claim 10, wherein the method further comprises the step of identifying relevant objects which are combined of one or more types of objects.

14. The method of claim 10, wherein the one or more types of objects are selected from a group consisting of: species, shape, color, spots and flecks of the object.

15. The method of claim 10, the method further comprising the step of displaying a distribution of the population by said processor.

16. The method of claim 10, wherein the machine learning process is performed according to a provided parameter.

17. The method of claim 16, wherein the provided parameter is selected from a group consisting of: shape, color, spots, flecks of the object, position in space and locomotion of the object.
